(19) United States
(12) Patent Application Publication
(10) Pub. No.: US 2004/0202605 A1
(43) Pub. Date: Oct. 14, 2004

(54) Iron oxyhydroxides as ion intercalation materials and synthesis method thereof

(76) Inventors: Jun Xu, Piscataway, NJ (US); Gaurav Jain, Piscataway, NJ (US)

Correspondence Address: Kenneth Watov, Esq., WATOV & KIPNES, P.C., P.O. Box 247, Princeton Junction, NJ, 08550, US

(21) Appl. No.: 10/823,230

(22) Filed: Apr. 13, 2004

Related U.S. Application Data
(60) Provisional application No. 60/462,305, filed on Apr. 14, 2003.

(51) Int. Cl. C01G 49/02; H01M 4/52

(52) U.S. Cl. 423/632; 429/221

(57) ABSTRACT

Iron oxyhydroxide materials possessing short-range-order structure and nanostructured morphology capable of intercalating lithium ions and being used as electrodes for electrochemical energy devices including rechargeable lithium batteries, and synthesis method thereof.

### RELATED APPLICATION

The present Application claims priority to U.S. Provisional Patent Application Serial No. 60/462,305, filed Apr. 14, 2003, entitled “IRON OXYHYDROXIDES AS INTERCALATION MATERIALS,” the content of which is hereby incorporated by reference herein to the extent that it does not conflict herewith.

### FIELD OF THE INVENTION

The present invention is related generally to iron oxyhydroxide materials exhibiting useful electrochemical properties, and more particularly to nanostructured iron oxyhydroxide materials for use as electrode components in rechargeable lithium batteries, and methods for making and using the same.

### BACKGROUND OF THE INVENTION

Rechargeable lithium and lithium-ion batteries are among the most promising rechargeable battery systems existing today, due in part to their higher specific energies and longer operating life as compared to other systems. The cathode of these battery systems is typically a lithium intercalation host, which allows reversible insertion and removal of lithium ions into and from its structure. In rechargeable lithium batteries, a lithium metal foil is used as the anode. During discharge, the ions move through an electrolyte to the cathode where they are intercalated into the host structure of the cathode. Simultaneously, in the external circuit, electrons move from the anode to the cathode, yielding electrical energy. When the cell is being charged, the ions de-intercalate from the cathode and return to the anode.

A variety of transition metal compounds including, for example, lithium cobalt oxide and manganese oxide, have been found capable of functioning as intercalation hosts for lithium. The capacity for such host materials, or ion intercalation materials, to intercalate lithium determines the charge/discharge capacity and energy density of the corresponding rechargeable lithium and lithium-ion batteries. The selection of a suitable cathode is typically driven by several factors including cost, performance, environmental compatibility, and reliability.

Traditional host materials are typically composed of crystalline transition metal compounds with layered or tunnel structures that serve as facile pathways for lithium ions. Crystalline compounds are usually synthesized through solid-state routes under high temperature conditions. Such synthesis routes generally yield materials composed of thermodynamically stable phases with particle sizes in the micrometer range. One commonly used crystalline oxide is lithium cobalt oxide, the predominant host material in current rechargeable batteries. Lithium cobalt oxide is expensive and known to be highly toxic to the environment. These shortcomings have spurred a search for suitable host materials that are less expensive and more environmentally friendly, while exhibiting superior electrochemical performance over that of lithium cobalt oxide.

Iron-based oxide and oxyhydroxide compounds are extremely attractive as cathode materials from cost and environmental standpoints. These compounds are naturally very abundant and occur in many different phases and structures. Prior efforts on various iron oxide based intercalation host materials have focused on compounds possessing conventional crystalline structures and micrometer-sized particles (i.e., microcrystalline iron oxides). These studies have typically yielded disappointing results, primarily due to poor reversibility of these compounds, low voltage characteristics and sluggish intercalation kinetics.

Investigations of lithium intercalation characteristics of iron oxyhydroxides have been limited in extent. In general, the microcrystalline forms of the various iron oxyhydroxides appear to have problems of low capacities and poor reversibility. Recently, lithium intercalation properties of β-FeOOH or akagenite have been investigated and reported. Such compounds deliver a high discharge capacity, but yield a much lower charge capacity, due to irreversibility associated with the intercalation process, which severely limits long-term charge-discharge cycling. Derivatives based on the phase γ-FeOOH or lepidocrocite have also been investigated and reported by some researchers showing intercalation capacities in the range of 100-170 mAh/g. These compounds, however, require an organic intercalant present in the structure. The absence of the organic intercalant severely impairs the performance characteristics of the material. In addition, improvement in the reversibility of intercalation in the γ-FeOOH and its derivatives remains a challenge. To be a suitable alternative to the state-of-the-art lithium cobalt oxide, the cathode candidate should preferably exhibit a specific capacity of at least 140 mAh/g and specific energy of at least 500 mWh/g, with perfect reversibility upon charge-discharge cycling.

The phase α-FeOOH or goethite is the most stable and abundant phase among the iron oxyhydroxides. This compound possesses [FeO₆] octahedra arranged in a 2×1 tunnel architecture, which appears potentially favorable for ion transport. However, intercalation properties of α-FeOOH have not been reported before. It is particularly attractive to investigate the lithium intercalation characteristics of nanostructured forms of α-FeOOH. Potentially, the high surface area and relatively poorly crystalline structure of a nanostructured material allows facile lithium diffusion and limit the tendency for large structural changes, yielding higher intercalation capacities with superior reversibility.

Accordingly, there is a need to develop and produce an iron oxyhydroxide host material, which exhibits superior electrochemical properties including enhanced intercalation capacity, excellent rate capacity and capacity retention upon recharge/discharge cycling. There is a need to develop and produce a nanostructured iron oxyhydroxide, with a poorly crystalline structure, that bears similarity to the phase α-FeOOH and yields favorable electrochemical properties overcoming the known limitations of microcrystalline iron oxides and oxyhydroxides. There is a need to develop a synthesis route, capable of producing nanostructured iron oxyhydroxide host material that can be used as a cathode in rechargeable lithium batteries in a simple and cost efficient manner. There is a further need to produce a lower cost and more environmentally friendly cathode material for use in rechargeable batteries.

### SUMMARY OF THE INVENTION

The present invention is related to iron oxyhydroxides for use as ion intercalation hosts in rechargeable lithium batteries, and to a method for making the iron oxyhydroxide host materials. In particular, the iron oxyhydroxide host materials of the present invention are in the form of nanostructured ferric oxyhydroxides weakly resembling the phase α-FeOOH or goethite. In addition to being nanostructured, the iron oxyhydroxide materials of the present invention possess a short-range-order structure, and more specifically, the materials exhibit structural order in their crystal lattice only up to small length scales. This invention thus concerns nanostructured amorphous iron oxyhydroxide materials as well as nanocrystalline iron oxyhydroxide materials. Nanostructured forms of iron oxides provide promising uses in rechargeable batteries. The nanostructured morphology and lack of long-range-order in the crystal structure of such compounds help overcome limitations of phase transformations and sluggish lithium transport, thus offering the promise of desirable electrochemical properties and performance.

In accordance with the present invention, the iron oxyhydroxide materials are composed of nanometer-sized particles with high surface areas to yield enhanced electrochemical performance. The short-range-order nanostructured forms of iron oxyhydroxide materials of the present invention yield high lithium intercalation capacities with nearly perfect reversibility and are highly favorable as low-cost, environment-friendly cathodes for rechargeable lithium batteries. Another advantage of the short-range-order nanostructured iron oxyhydroxide materials of the present invention is their superior rate performance. These materials yield large intercalation capacities at very high current rates with excellent capacity retention upon charge-discharge cycling.

Furthermore, the nanostructured iron oxyhydroxide materials of the present invention are preferably produced through low-temperature aqueous solution routes, thus enabling synthesis to be carried out in a simple, cost effective and environmentally friendly manner. Particular attention has been directed to the synthesis of short-range-order forms of ferric oxyhydroxide composed of nanometer sized particles using such soft chemistry procedures.

The present invention is directed to ferric oxyhydroxides for use as intercalation host materials for rechargeable lithium batteries. The nanostructured iron oxyhydroxide materials of this invention, with short-range-order structures, exhibit excellent electrochemical performance that is far superior to the performance reported for any microcrystalline iron-based oxide or iron-based oxyhydroxide. The low cost and environmental friendliness of the present nanostructured ferric oxyhydroxides, coupled with their performance, make them desirable cathode candidates for rechargeable lithium batteries.

In one aspect of the present invention, there is provided an iron oxyhydroxide material for use as an ion intercalation host, which is composed of nanometer-sized iron oxyhydroxide particles with short-range-order structures.

In a further aspect of the present invention, there is provided an iron oxyhydroxide material for use as an intercalation host, which possesses a short-range-order structure, weakly resembling the phase goethite or α-FeOOH.

In another aspect of the present invention, there is provided an iron oxyhydroxide material for use as an ion intercalation host, which comprises a nanostructured ferric oxyhydroxide produced via aqueous oxidative hydrolysis and heat treatment.

In another aspect of the present invention, there is provided a method for preparing an iron oxyhydroxide material capable of intercalating lithium ions, comprising the steps of:

oxidizing Fe(II) via hydrolysis to yield FeOOH; and

dehydrating FeOOH at a temperature and for a time sufficient to yield nanostructured phases composed of substantially amorphous, nanometer-size particles of FeOOH.

In a further aspect of the present invention, there is provided an iron oxyhydroxide material for use as an ion intercalation host produced through the steps of the method of the present invention.

### BRIEF DESCRIPTION OF THE DRAWINGS

Various embodiments of the invention are described in detail below with reference to the drawings, in which like items are identified by the same reference designation, wherein:

FIG. 1A shows a flowchart depicting the steps for synthesizing a nanostructured amorphous ferric oxyhydroxide in accordance with one embodiment of the present invention;

FIG. 1 depicts x-ray powder diffraction (XRD) measurements of (a) a nanostructured, amorphous form of α-iron oxyhydroxide (α-FeOOH); (b) a nanostructured amorphous form of α-ferric oxide obtained by heating the nanostructured amorphous α-FeOOH at 250° C. in air for 24 hours; and (c) α-ferric oxide obtained by heating the nanostructured amorphous α-FeOOH at 500° C. in air for 48 hours;

FIG. 2 is a graph representing a thermogravimetric analysis of the nanostructured amorphous ferric oxyhydroxide prepared in Example 1;

FIG. 3 is a field-emission scanning electron microscope image of the nanostructured amorphous ferric oxyhydroxide prepared in Example 1;

FIG. 4 is a graph of discharge and charge curves at C/100 (62 μA/cm²) for the nanostructured amorphous ferric oxyhydroxide prepared in Example 1;

FIG. 5 is a graph of first discharge curves at three different rates for the nanostructured amorphous ferric oxyhydroxide prepared in Example 1;

FIG. 6 is a graph of discharge curves and cyclability at C/10 (0.53 mA/cm²) for the nanostructured amorphous ferric oxyhydroxide prepared in Example 1; and

FIG. 7 is a graph of cycling performance and charge coefficient at C/10 (0.53 mA/cm²) for the nanostructured amorphous ferric oxyhydroxide prepared in Example 1; and

FIG. 8 is a graph showing the discharge and charge capacity upon cycling at a high current of rate C/1(4.9 mA/cm²) for the nanostructured amorphous ferric oxyhydroxide prepared in Example 1.

### DETAILED DESCRIPTION OF THE INVENTION

The present invention is directed to iron oxyhydroxide materials capable of intercalating lithium ions and a method for preparing the same. The iron oxyhydroxide materials of the present invention are readily produced through relatively low temperature soft chemistry routes of synthesis. The iron oxyhydroxide materials of the present invention have been found to possess short-range-order structures, weakly resembling the phase α-FeOOH, and nanostructured morphologies, wherein the particle sizes of the material are within the nanometer range. The nanostructured iron oxyhydroxide materials of the present invention have further been found to exhibit enhanced electrochemical properties as compared to the corresponding microcrystalline counterparts.

In particular, the short-range-order iron oxyhydroxide materials of the present invention have been found to exhibit high intercalation capacities and specific energies, superior rate performance and reduced susceptibility to undesirable irreversible phase changes. As a result of the reduced susceptibility to undesirable irreversible phase changes, the iron oxyhydroxide materials of the present invention have been found to desirably maintain good reversibility over long term use as compared with conventionally produced crystalline iron-based oxides and oxyhydroxides composed of micrometer sized particles.

The term “short-range-order” is used herein to describe a solid that lacks long-range periodicity in the crystal lattice, and encompasses compounds that do not show any peaks or show few weak peaks in their powder x-ray diffraction pattern. In literature, such solids are often referred to as amorphous, disordered or nanocrystalline. The term “nanostructured” is used to characterize a solid possessing a morphology with characteristic lengths in the nanometer range, in particular, a solid in particulate form having particle sizes between 1 and 100 nanometers.

Applicants note that microcrystalline iron oxyhydroxides have been investigated briefly in the past for lithium intercalation, and have typically exhibited poor electrochemical performance. The short-range-order nanostructured iron oxyhydroxide materials of the present invention have a structure weakly resembling the structure of crystalline α-FeOOH or goethite. Applicants have synthesized microcrystalline α-FeOOH via a well-established laboratory synthesis route and observed drastic differences in the electrochemical performance of the microcrystalline compound and the short-range-order, nanostructured iron oxyhydroxide materials of the present invention. In particular, Applicants have discovered that short-range-order nanostructured iron oxyhydroxide materials of the present invention exhibits higher specific capacity, superior capacity retention upon cycling and superior high rate performance as compared to the microcrystalline α-FeOOH materials, making the nanostructured iron oxyhydroxide materials of the present invention an attractive, low-cost cathode candidate for rechargeable lithium batteries.

Iron-based oxides, in particular iron oxyhydroxides, have been found to be potential attractive alternatives to the state-of-the-art lithium cobalt oxide from cost and environmental standpoints. Applicants have found that iron oxyhydroxides with short-range-order structure and nanostructured morphology avoid the problems of phase transformations and sluggish kinetics typically associated with conventional microcrystalline iron oxyhydroxides. Shorter diffusion lengths and facile diffusion due to the large fraction of disordered surface structure are some of the characteristics associated with nanostructured morphology, and have been found to yield high intercalation capacities at practical discharge rates. Moreover, the short-range-order, nanostructured iron oxyhydroxide materials of the present invention exhibit a decreased tendency to undergo detrimental phase transformations upon intercalation/deintercalation. Applicants believe that the far-from-equilibrium, short-range-order structure makes it kinetically very difficult for any phase transformation to the crystalline equilibrium structure to occur. Applicants further believe that the larger contribution of surface energy in the case of nanostructured materials may have a diminishing effect on the thermodynamic driving force that produces such undesirable phase transformations. These factors facilitate larger single-phase intercalation capacities and improved reversibilities. Applicants have also found that an increase in the porosity of the iron-based oxyhydroxide greatly enhances the lithium intercalation kinetics resulting in a higher intercalation capacity at a given rate. Applicants further believe that the more disordered or amorphous the iron oxyhydroxide material is, the more isotropic the volume changes associated with intercalation become, which reduces the tendency for structural disintegration of the cathode, thereby yielding enhanced cycling performance. Applicants theorize that the nanostructured and substantially amorphous structure of the iron oxyhydroxide materials of the present invention, and the low temperature synthesis route employed for their synthesis, lead to intercalation hosts characterized by higher incidence of defects and presence of cationic vacancies in the structure. Such vacancies are believed to serve as facile pathways for lithium transport and may also act as additional sites for lithium intercalation.

The short-range-order nanostructured iron oxyhydroxide materials of the present invention have been found to be stable intercalation hosts for lithium and exhibited intercalation capacities of at least 0.5 mole of lithium per mole of FeOOH, preferably about 1 mole of lithium. The iron oxyhydroxide materials of the present invention remain largely amorphous over the whole intercalation range and this facilitates a reversible lithium insertion process. When used as intercalation cathodes for lithium-based batteries, the iron oxyhydroxide materials of the present invention yield a specific capacity of at least 80 mAh/g, and preferably at least 215 mAh/g at a rate of C/10 or 0.53 mA/cm², and store energy at the level of at least 400 mWh/g, preferably at least 500 mWh/g at a rate of about C/10 (C/10 refers to a current rate equivalent to intercalation to the full capacity of the cathode material, 1 Li/FeOOH in this case, in 10 hours).

The present invention is directed to iron oxyhydroxide materials useful as ion intercalation hosts, and in particular lithium intercalation hosts for use in rechargeable battery electrodes (i.e., cathodes). Further, the present invention is directed to the synthesis of the iron oxyhydroxide materials composed of ferric oxyhydroxide synthesized through an aqueous oxidative hydrolysis procedure followed by a heat treatment to yield a desired product having a short-range-order, nanostructured morphology.

The iron oxyhydroxide material of the present invention comprises ferric oxyhydroxide with a short-range-order structure and nanostructured morphology, which can be synthesized using low temperature soft chemistry processes. The synthesis method generally comprises preparing an aqueous solution of a soluble Fe(II) salt which is oxidized in the presence of strongly alkaline conditions (e.g., pH˜11 to 12) to yield a precipitate. Suitable Fe(II) salts for the synthesis include, for example, FeCl₂, Fe(NO₃)₂, Fe(CH₃COO)₂ and the like. The pH level is selected to facilitate the precipitation of the phase α-FeOOH or goethite. The resulting powder precipitates can be separated from the reaction mixture through centrifuging and subsequently processed by freeze-drying techniques. Thereafter, the α-FeOOH product is heated under vacuum at a temperature and for a time sufficient to facilitate dehydration to yield the desired nanostructured ferric oxyhydroxide.

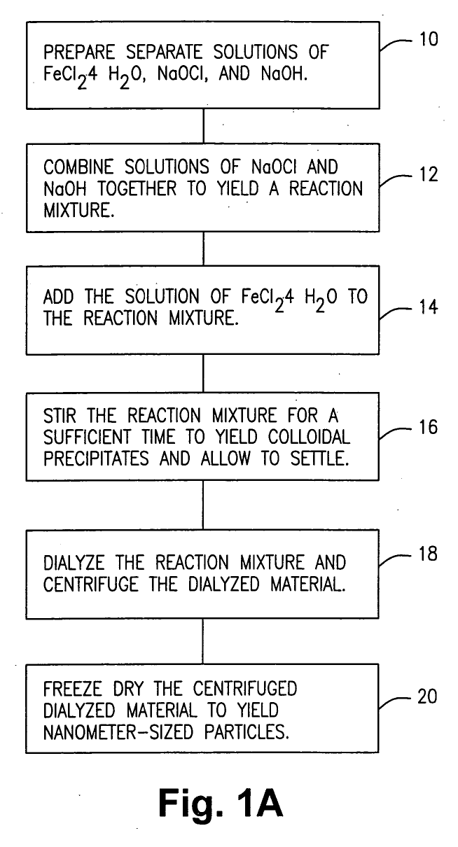

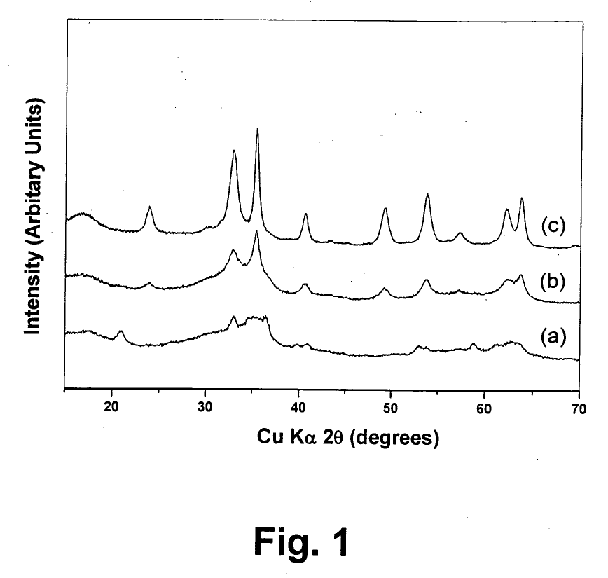

With reference to FIG. 1A, a flowchart illustrates the steps for synthesizing the nanostructured iron oxyhydroxide in one embodiment of the present invention. Solutions containing one of following: iron chloride (FeCl₂), sodium hypochlorite (NaOCl) and sodium hydroxide (NaOH) are prepared separately in predetermined molar ratios as indicated in step 10. The solutions containing NaOCl and NaOH are combined and thoroughly mixed to yield a reaction mixture having a pH of about 12 as indicated in step 12. The solution containing FeCl₂ is added to the reaction mixture and thoroughly stirred as indicated in step 14. The Fe²⁺ species is oxidized to yield species of higher valence, including Fe³⁺ in the form of colloidal FeOOH precipitates. The resulting reaction mixture is stirred for a sufficient time, preferably about 1.5 hours, and then allowed to stand for about 24 hours to permit the precipitates to settle out as indicated in step 16. The reaction mixture is thereafter washed and dialyzed for about 5 days using low pass dialysis films in deionized water with the resulting dialyzed material centrifuged as indicated in step 18. The centrifuged material is subsequently freeze-dried to yield nanometer-sized iron oxyhydroxide particles as indicated in step 20.

The synthesis method of the present invention can be modified through variations in the ratio amounts of the corresponding reactants, which alters the crystalline nature and electrochemical performance of the desired products. In particular, Applicants have discovered that the crystallinity of the oxyhydroxide product can be regulated by the amount of the oxidizing agent used. For example, the molar ratio of the reactants FeCl₂:NaOCl can be varied from about 1:1.5 to 1:5 to yield an amorphous structure material at the 1:1.5 ratio, and a nanocrystalline structure material at the 1:5 ratio. It is noted that the variation in the amount of oxidizing agent used does not appear to substantially influence the high surface area morphology of the product. The overall electrochemical performance of the iron oxyhydroxide diminishes slightly with increasing crystallinity. Accordingly, it is highly desirable to produce a product that is substantially amorphous for use as an intercalation host in rechargeable lithium batteries.

Applicants have evaluated the intercalation characteristics of microcrystalline α-FeOOH or goethite sample, which was synthesized through a known laboratory synthesis procedure as reported by Schwertmann and Cornell in “Iron Oxides in the Laboratory”, pp. 61, VCH, Germany, 1991. The resulting microcrystalline α-FeOOH sample exhibited a high initial capacity, which rapidly diminished over repeated cycling to a capacity of less than 100 mAh/g. This reduction in capacity appears to be related to the material undergoing irreversible phase transformations. This is different from the performance observed in short-range-order nanostructured iron oxyhydroxides of the present invention. The iron oxyhydroxide materials of the present invention, particularly those of substantially amorphous structures, exhibited near perfect reversibility and stable intercalation capacities over repeated cycling.

After freeze-drying, the nanometer-sized iron oxyhydroxide particles can be heat treated in a vacuum at a temperature sufficient to initiate dehydration. The dehydration process aids in removing water that may be present, while preserving the short-range-order structure of the particles. The temperature at which the particles are heat-treated can range up to about 200° C., and preferably up to about 80° C. The particles are generally heated for about 24 to 48 hours to yield the desired nanostructured iron oxyhydroxide particles. The Brunauer-Emmett-Teller (BET) specific surface area of the resulting nanostructured iron oxyhydroxide particles has been measured to be greater than 200 m²/g, and typically about 300 m²/g.

Applicants carried out X-ray diffraction analyses to determine the crystal structure/phase and the crystallinity of the precipitates produced by the aqueous oxidation reaction, and it was determined from the analyses that the precipitates were short-range-order forms of the phase α-iron oxyhydroxide (α-FeOOH). The iron oxyhydroxide materials synthesized at lower molar ratios of FeCl₂:NaOCl had a significantly more amorphous character. Applicants determined that the temperature of the heat treatment was critical to maintaining the short-range-order structure of the desired product, while drying the product for use as an intercalation host. Applicants observed that by heating the iron oxyhydroxide material at a higher temperature, specifically at temperatures above 250° C., the final product was found to possess a more crystalline structure and exhibited a tendency to be converted into the phase α-Fe₂O₃ or hematite.

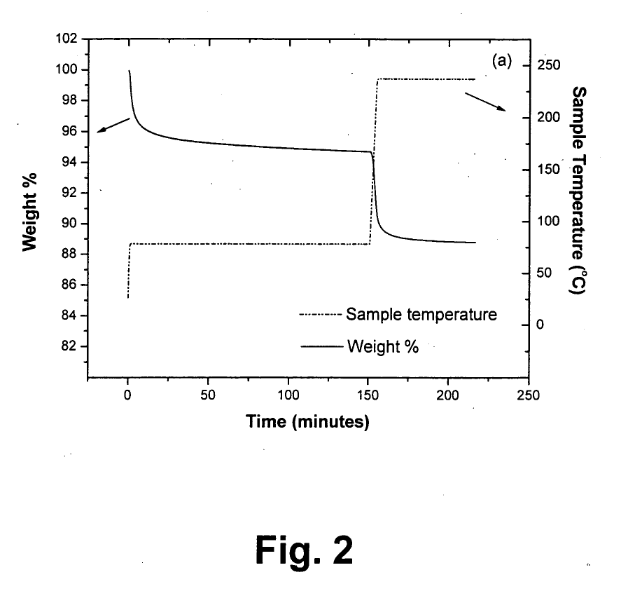

With reference to FIG. 2, X-ray powder diffraction (XRD) analysis of the nanostructured iron oxyhydroxide was performed on a Siemens Diffraktometer using Cu K_{α} radiation (λ=1.5418 Å). The X-ray diffraction (XRD) spectrum of the powder precipitates identified by (a) indicates that the material is a structurally disordered or amorphous form of α-FeOOH. This nanostructured amorphous product was obtained after heating the powder precipitates from the aqueous solution synthesis under vacuum at an elevated temperature for a sufficient time to dehydrate the material, while at least substantially maintaining the amorphous structure. In a preferred embodiment of the present invention, the powder precipitate is heated to a temperature of up to 200° C., preferably at about 80° C., for about 24 hours. Upon heating this material at 250° C. or 500° C., more crystalline forms of the ferric oxide, α-Fe₂O₃ are obtained, as confirmed by XRD patterns shown in FIGS. 2(b) and 2(c), respectively.

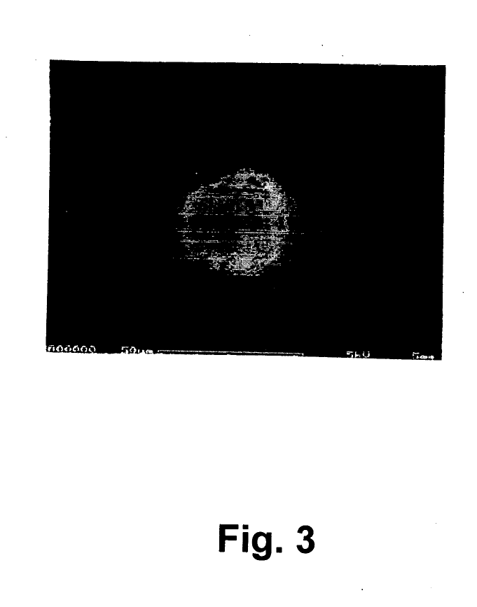

Referring to FIG. 3, a Field-Emission Scanning Electron Microscope (FESEM) image of the nanostructured amorphous iron oxyhydroxide is shown to illustrate the nanostructured morphology. The FESEM image confirms nanostructured morphology with the characteristic length of the particles in the range of from about 1 to 100 nanometers, preferably from about 30 to 40 nm. The iron oxyhydroxide material of the present invention is characterized by low or poor crystallinity, and high porosity with high specific surface area. A combination of flame atomic absorption spectroscopy, thermogravimetric analysis and iodometric titration were employed to ascertain the overall composition of the product. In one example, a typical composition of the dehydrated iron oxyhydroxide produced above for one embodiment can be presented as NaₓFe(OOH)_{y} with 0≦x≦0.25 and 0.9≦y≦1.33 varying with the ratios of the reactants used.

The nanostructured iron oxyhydroxide of the present invention is generally characterized by a short-range-order structure, which is confirmed by the x-ray diffraction pattern of the material exhibiting few weak and very broad peaks. The nanostructured iron oxyhydroxide further exhibits high porosity with a total surface area of typically greater than 200 m²/g, and typically about 300 m²/g.

### EXAMPLES

### Example 1

### Synthesis Procedure for Producing Nanostructured Amorphous Ferric Oxyhydroxide

Iron oxyhydroxide was synthesized via a room temperature aqueous solution route comprising oxidation of Fe (II) precursor compounds such as ferrous chloride with an oxidizing agent such as sodium hypochlorite in an alkaline medium. Aqueous solutions of FeCl₂.4H₂O, NaOCl and NaOH were separately prepared to yield a molar ratio for FeCl₂.4H₂O:NaOCl:NaOH of 1:2.5:5.0. The NaOCl and NaOH solutions were stirred together to yield a reaction mixture having a pH of about 12.85. The FeCl₂.4H₂O precursor solution was added to the reaction mixture to yield a precipitate. The reaction mixture was stirred for about 1.5 hours, and allowed to settle for about 24 hours. The reaction mixture was thereafter dialyzed for about 5 days using a low-pass dialysis tubing in deionized water. The dialyzed product was centrifuged and freeze-dried to yield nano-sized particles comprising the nanostructured amorphous iron oxyhydroxide of the present invention.

### Example 2

### Determination of the Chemical Composition of the Nanostructured Amorphous Ferric Oxyhydroxide Produced in Example 1 Via Elemental Analysis and Mean Oxidation State Determination of Iron

Flame atomic absorption spectroscopy was carried out to obtain the elemental composition of the nanostructured amorphous ferric oxyhydroxide produced in Example 1, and an iodometric titration process was implemented to determine the mean oxidation state of iron. The processes were carried out to determine the overall chemical composition of the nanostructured amorphous ferric oxyhydroxide. Flame atomic absorption analysis revealed the weight percentage of iron and sodium in the material, thereby enabling the molecular weight of the material to be inferred.

The iodometric titration process was initiated by dissolving a small amount of the ferric oxyhydroxide of Example 1 in concentrated hydrochloric acid along with mild heating in an Erlenmeyer flask. Upon complete dissolution, potassium iodide was added to the reaction mixture and the mixture was maintained in the dark for a few minutes. The ferric ions in the solution were allowed to react with the iodide ions. The reaction reduced the ferric ions to ferrous ions, and oxidized a stoichiometric amount of iodide ions to iodine. The iodine was thereafter titrated with a 0.5 M sodium thiosulfate solution. A starch-based indicator was added upon the loss of the iodine color. The addition of the starch-based indicator turned the solution blue due in part to the presence of residual iodine. The solution was further titrated with sodium thiosulfate until the blue color disappeared completely. The mean oxidation state of iron was calculated by measuring the amount of thiosulfate used. The mean oxidation state of iron was determined to be +2.96. The concentration of the anionic species, O²⁻ and (OH)⁻ in the material was determined based on the mean oxidation state of iron and the concentration of Na⁺. The remaining weight was attributed to the presence of absorbed water and/or structural water in the material. The molecular formula obtained through the above analysis of the nanostructured amorphous ferric oxyhydroxide of Example 1 was determined to be Na_{0.01}Fe(OOH)_{0.99}.0.27H₂O.

### Example 3

### Structural and Thermal Analysis of the Nanostructured Amorphous Ferric Oxyhydroxide of Example 1

X-ray powder diffraction (XRD) was performed on a Siemens Diffraktometer using Cu K_{α} radiation (λ=1.5418 Å). To prevent the weak signals of the nano-sized and nearly amorphous samples from getting obscured by Fe K_{α} fluorescence, a graphite monochromator was mounted between the sample and the detector. Measurements were made slowly, using a 2θ step size of 0.05° and dwell time of 20 seconds at each step.

Referring to FIG. 1, powder X-ray diffraction patterns were taken of the nanostructured amorphous ferric oxyhydroxide, and the materials upon heating to 250° C. and 500° C., respectively. Pattern (a) represents the ferric oxyhydroxide obtained from the iron oxyhydroxide of Example 1, after dehydration at 80° C. under vacuum. The spectrum shows broad weak peaks corresponding to the more defined peaks of α-FeOOH or goethite. The pattern (a) of FIG. 1 shows no evidence of the presence of an oxide indicating that the heat treatment of the material at 80° C. under vacuum for about 24 hours facilitates the removal of the adsorbed water and/or structural water, but does not convert the oxyhydroxide to an oxide.

Goethite or α-FeOOH is known to lose water and convert into hematite, or α-Fe₂O₃ upon heating at an elevated temperature. Pattern (b) represents a material produced by heating the nanostructured amorphous ferric oxyhydroxide to a temperature of about 250° C. for about 24 hours in air, and pattern (c) represents a material produced by heating the nanostructured amorphous ferric oxyhydroxide to a temperature of about 500° C. for about 48 hours in air. Patterns (b) and (c) clearly exhibit peaks corresponding closely to α-Fe₂O₃ (hematite). However, each of the patterns also exhibits anisotropic line broadening characteristics that are typically associated with goethite-derived hematite, and the evolution of the patterns from (a) to (c) is most typical of such transformation. Accordingly, it is believed based on the observations made above that the material prepared in Example 1 is a nearly amorphous form of α-FeOOH or goethite.

Thermogravimetric analysis (TGA) was conducted under flowing dry nitrogen gas using a Perkin-Elmer TGA-7 instrument available from Perkin-Elmer, Norwalk, Conn. During the thermal analysis, the as-prepared iron oxyhydroxide of Example 1 was initially kept isothermally at 80° C. and the weight loss was simultaneously measured. The TGA analysis indicates that the material loses the adsorbed and/or structural water at the temperature of about 80° C. Referring to FIG. 2, the material is shown losing 5.0 to 5.2 percent by weight water when maintained at about 80° C. which corresponds to the weight loss expected from the loss of the 0.27H₂O as predicted by the formula Na_{0.01}Fe(OOH)_{0.99}.0.27H₂O determined in Example 2. There was negligible weight loss thereafter at the temperature of about 80° C. However, when the temperature was raised to 240° C., significant weight loss was observed due largely in part to the conversion of the oxyhydroxide to the oxide form as shown in FIG. 2.

TGA analysis of the material prepared in Example 1 was also performed over a temperature ramp of from room temperature to about 600° C. at 5° C. per minute in the presence of flowing nitrogen gas, which exhibited a net weight loss of about 15.2%. This measured value is in close agreement with the 14.7% expected weight loss, based on the molecular formula determined above and the decomposition reaction:

Na_{0.01}Fe(OOH)_{0.99}.0.27 H₂O→½(Na_{0.02}Fe₂O_{2.97})+(0.27+0.495)H₂O

Accordingly, the amorphous ferric oxyhydroxide material of Example 1 converts to ferric oxide upon exposure to substantially high temperatures.

### Example 4

### Electrochemical Characterization of the Nanostructured Amorphous Ferric Oxyhydroxide of Example 1

For characterizing the electrochemical properties of the synthesized nanostructured amorphous iron oxyhydroxide of Example 1, a composite of the iron oxyhydroxide combined with Ketjen black carbon and polytetrafluoroethylene as the binder, in the weight ratios of 60:30:10, was prepared. This composite mix was stirred in cyclohexane for 24 hours, and vacuum dried for 24 hours. The resulting mixture was rolled into a sheet, and punched to yield 0.25 inch diameter pellets. The pellets were thereafter pressed in a 0.25 inch die at about 1 metric ton for about 5 minutes to yield pressed pellets having a thickness of from about 150 to 200 μm. A stainless steel wire mesh was gently pressed into the pellets to operate as a current collector. The pellets were then dried at about 80° C. for 24 hours in a vacuum oven. Thereafter, the pellets were transferred while avoiding exposure to air to a glove box for testing. The pellets were tested in laboratory glass cells with lithium metal foils for use as counter and reference electrodes in the presence of 1M LiClO₄ in 1:1 by volume propylene carbonate:1,2-dimethoxyethane (PC:DME) as the electrolyte. A Maccor battery tester was used for charge/discharge tests between 4.3 and 1.5 V versus Li⁺/Li at different current rates.

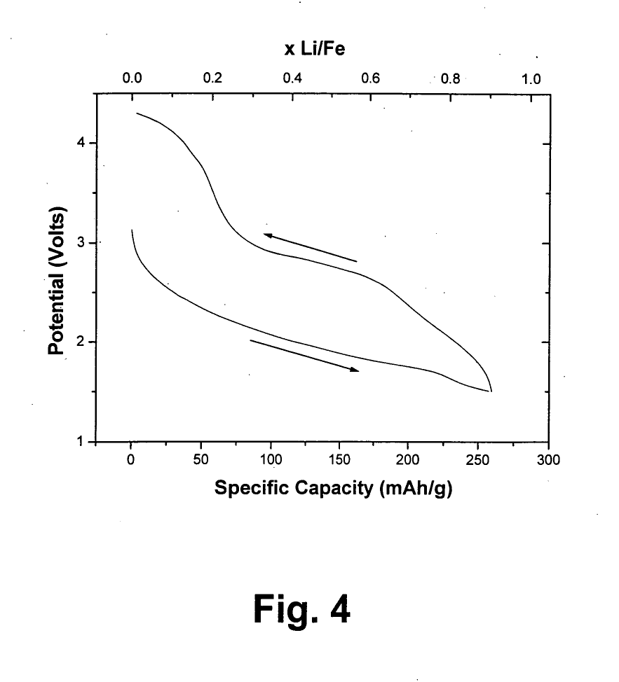

Referring to FIG. 4, discharge and charge curves on a first cycle run of the nanostructured amorphous ferric oxyhydroxide upon heating at about 80° C. under vacuum for about 24 hours are shown. The test was conducted at a rate of C/100 (62 μA/cm²). The test sample was first discharged from an open circuit voltage (OCV) of 3.1 V to 1.5 V, and then charged to about 4.3 V. The specific capacity obtained was about 260 mAh/g. Applicants have further observed that the specific capacity is nearly completely reversible since the charging step subsequent to the first discharge exhibited a charge capacity of about 257 mAh/g, deintercalating 98.8% of the intercalated lithium from the material as shown in FIG. 4. This is one of the highest reported reversible lithium intercalation capacities among iron-based oxide or oxyhydroxide compounds. The near-perfect reversibility of the compound towards such a high-capacity intercalation indicates the suitability of this short-range-order, nanostructured material as a suitable reversible intercalation host.

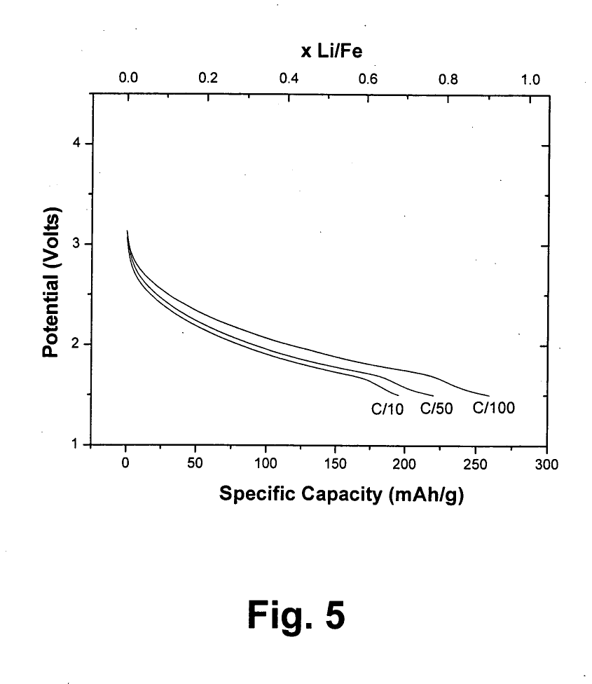

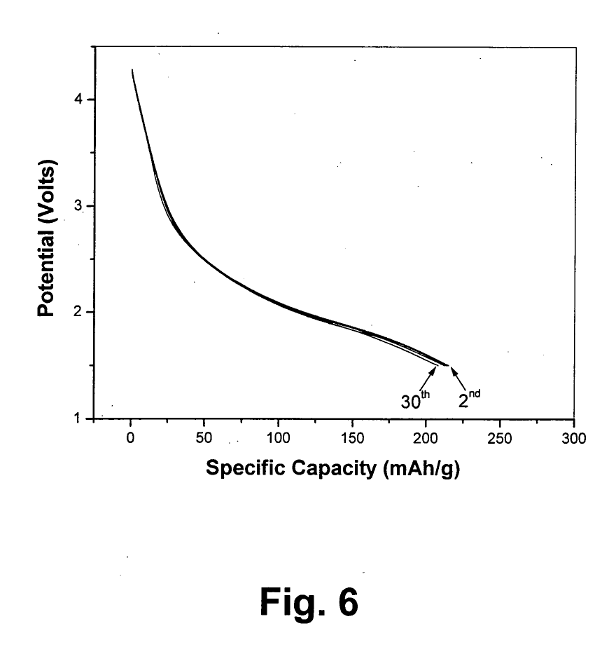

Referring to FIG. 5, voltages curves for the first discharge of the nanostructured amorphous ferric oxyhydroxide at three different rates, namely, C/100 (62 μA/cm²), C/50 (0.10 mA/cm²), and C/10 (0.53 mA/cm²). Specific capacities of 260, 220 and 195 mAh/g were observed at the three rates, respectively. The capacity of the C/10 test was 215 mAh/g from the second cycle as shown in FIG. 6. Applicants believe that the amorphous structure may provide a large free volume, which facilitates a fast ion diffusion to yield the excellent rate capability.

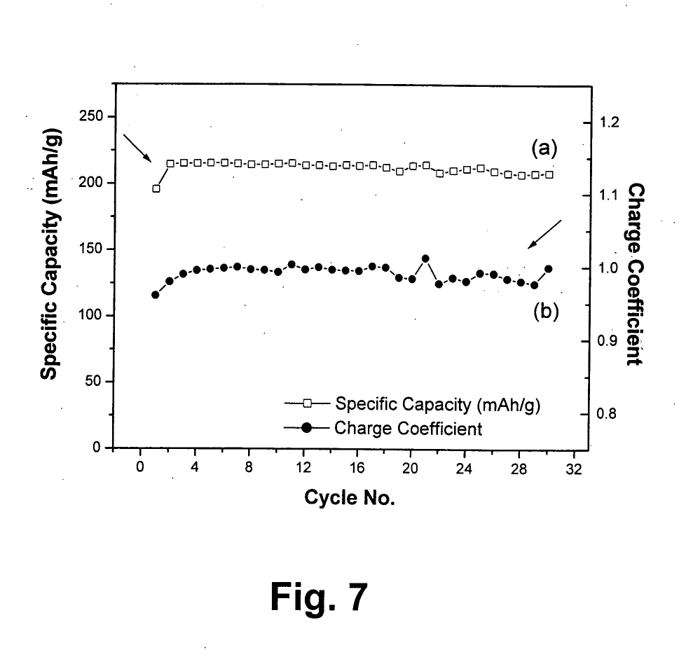

Referring to FIG. 6, discharge voltage profiles are shown for second to thirtieth cycles at C/10 rate (0.53 mA/cm²). The first discharge was implemented from an open circuit voltage of 3.1 V to 1.5 V, and subsequent charge/discharge was between 1.5 and 4.3 V. The discharge capacity was observed at C/10 to be about 195 mAh/g for the first cycle and 215 mAh/g for subsequent cycles, and a plot of the specific capacity versus cycle number is shown by curve (a) in FIG. 7, which exhibits a nearly perfect cycling performance from the second cycle beyond. The monotonically decreasing and smooth voltage profiles from the second cycle on, as shown in FIG. 6, appears to be consistent with a single-phase intercalation process in an amorphous structure. The absence of any appreciable changes in the voltage profiles over cycling, as shown in FIG. 6, suggests that the amorphous structure may be relatively stable during the repeated lithium intercalation/deintercalation processes. The nearly perfect cycling performance and the charge coefficient (ratio of charge capacity to discharge capacity) constantly at near unity over cycling as shown by curve (b) in FIG. 7, indicate that no side reactions or parasitic reactions occur, other than the intercalation/deintercalation reactions.

The specific capacity of 260 mAh/g of the ferric oxyhydroxide material obtained at the C/100 rate (as shown in FIG. 4) corresponds to an intercalation of about 0.9 Li per Fe. The mean oxidation state of Fe in the material prior to discharge was +2.96. Nearly all Fe (III) ions in the host were reduced to Fe (II) at the end of the discharge. The lithium intercalation reaction was able to proceed to the full extent that the redox reaction of the electrochemically active center, Fe (III), permits.

The specific energy delivered by the nano-sized amorphous ferric oxyhydroxide material was about 525 mWh/g at the C/100 rate, about 475 mWh/g at the C/10 rate, which are each comparable with 500 mWh/g for the commercially available LiCoO₂. This specific energy, in combination with the excellent rate capability and cycling performance, provides a viable cathode candidate for rechargeable lithium batteries utilizing cost effective and environmentally friendly materials.

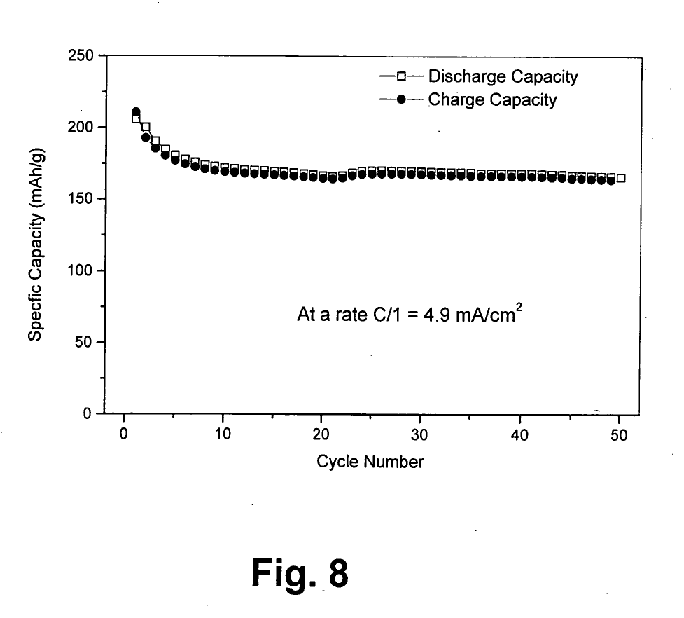

FIG. 8 shows the charge/discharge capacity of the nanostructured amorphous iron oxyhydroxide of Example 1 at a very high discharge rate of 4.9 mA/cm², equivalent to C/1. The material yields a steady capacity of close to 170 mAh/g with excellent charge/discharge reversibility. This performance indicates the large promise of this nanostructured high-surface-area amorphous material for high power battery applications. The high-rate capability of the nanostructured amorphous iron oxyhydroxide also makes it a promising electrode candidate for asymmetric electrochemical supercapacitors. The asymmetric supercapacitors are hybrid electrochemical energy devices with one of the electrodes based on double-layer capacitance and the other electrode functioning as a battery electrode. Owing to the facile lithium intercalation kinetics and superior reversibility, the nanostructured amorphous iron oxyhydroxides of the current invention are attractive as high rate battery electrodes for these hybrid energy devices as well.

Although various embodiments of the invention have been shown and described, they are not meant to be limiting. Those of skill in the art may recognize certain modifications to these embodiments, which modifications are meant to be covered by the spirit and scope of the appended claims. Various modifications of the material of the present invention can be made, such as cation doped forms to yield higher energy and higher capacities while retaining the superior cycling performance and stability of these materials. The material of the present invention can readily be lithiated for use as cathodes for lithium ion batteries as well.

What is claimed is:

1. An iron oxyhydroxide material capable of intercalating lithium ions composed of nanometer-sized iron oxyhydroxide particles with short-range-order structures.

2. The iron oxyhydroxide material of claim 1, wherein the lithium ion intercalating capacity is at least 0.5 moles of lithium ions per mole of iron oxyhydroxide.

3. The iron oxyhydroxide material of claim 1, wherein the lithium ion intercalating capacity is at least 1.0 moles of lithium ions per mole of iron oxyhydroxide.

4. The iron oxyhydroxide material of claim 1, wherein the particles are less than 100 nm in size.

5. The iron oxyhydroxide material of claim 1, wherein the particles are about 30 nm in size.

6. The iron oxyhydroxide material of claim 1, wherein the iron oxyhydroxide has a short-range-order structure, weakly resembling the phase α-FeOOH or goethite.

7. The iron oxyhydroxide of claim 1, wherein the chemical composition of the compound is NaₓFe(OOH)_{y}, for 0≦x≦0.25 and 0.9≦y≦1.33.

8. The iron oxyhydroxide material of claim 1, wherein the iron oxyhydroxide particles exhibit high porosity.

9. The iron oxyhydroxide material of claim 8, wherein the particles exhibit a Brunauer-Emmett-Teller specific surface area of at least 200 m²/g.

10. The iron oxyhydroxide material of claim 1, further comprising a specific capacity of at least 80 mAh/g at a rate of 0.53 mA/cm².

11. The iron oxyhydroxide material of claim 1, further comprising a specific capacity of at least 215 mAh/g at a rate of 0.53 mA/cm².

12. The iron oxyhydroxide material of claim 1, comprising an energy storage capacity of at least 400 mWh/g at a rate of 0.53 mA/cm².

13. The iron oxyhydroxide material of claim 1, comprising an energy storage capacity of at least 525 mWh/g at a rate of 0.53 mA/cm².

14. A method for preparing an iron oxyhydroxide material capable of intercalating lithium ions, comprising the steps of:
oxidizing Fe(II) via hydrolysis to yield FeOOH; and
dehydrating FeOOH at a temperature and for a time sufficient to yield at least substantially amorphous nanometer-size particles of FeOOH.

15. The method of claim 14, wherein said oxidizing step further comprises mixing an aqueous solution of Fe (II) with a mixture containing NaOCl and NaOH at ambient temperature to yield a reaction mixture.

16. The method of claim 15, wherein the molar ratio of Fe(II):NaOCl:NaOH ranges from 1:1.5:5 to 1:5:5.

17. The method of claim 15, wherein the molar ratio of Fe(II):NaOCl:NaOH is about 1:2.5:5.

18. The method of claim 15, further comprising stirring the reaction mixture for about 1.5 hours, and settling the reaction mixture for about 24 hours.

19. The method of claim 17, further comprising dialyzing the reaction mixture for about 5 days through low-pass dialysis films in deionized water to yield a dialyzed material.

20. The method of claim 19, further comprising centrifuging the dialyzed material, and freeze drying the centrifuged and dialyzed material to yield nanometer-sized powders.

21. The method of claim 14, wherein Fe(II) is selected from the group consisting of FeCl₂, Fe(NO₃)₂, and Fe(CH₃COO)₂.

22. The method of claim 14, wherein the dehydrating step further comprises heating FeOOH to a temperature of up to 80° C. in ambient air for about 24 hours.

23. An iron oxyhydroxide material prepared by the method of claim 14.
